(19) United States
(12) Patent Application Publication
(10) Pub. No.: US 2007/0091273 A1
(43) Pub. Date: Apr. 26, 2007

(54) MONITORING DEVICES FOR INHALER VALVES

(76) Inventor: MICHAEL HENNESSY SULLIVAN, Droitwich (GB)

Correspondence Address: HOFFMAN WARNICK & D'ALESSANDRO, LLC, 75 STATE STREET, 14TH FLOOR, ALBANY, NY, 12207, US

(21) Appl. No.: 11/467,276

(22) Filed: Aug. 25, 2006

Related U.S. Application Data
(63) Continuation of application No. PCT/GB05/00793, filed on Mar. 2, 2005.

(30) Foreign Application Priority Data
Mar. 2, 2004 (GB) 0404700.7

(51) Int. Cl. G03B 21/00

(52) U.S. Cl. 353/31

(57) ABSTRACT

The operation of a valve in a medicant dispenser for example, is monitored by an optical system. When the valve is first moved to its open position, a light passage from a valve component to a light sensor is defined. Upon each subsequent operation of the valve which allows light to pass along the passage, the sensor sends a signal to a counter which keeps a record of use of the valve.

The present invention relates to a device for monitoring the operation of valves. It has particular application in dispensers for delivering doses of medicant, orally, nasally or sub-lingually. Inhalers are of especial signifance in this respect.

In inhalers and other medical devices where the dosage delivery of a medicant has to be carefully controlled, the operation of any valve through which a medicant is delivered has to be carefully monitored. Where the opening of a valve releases a predetermined quantity of medicant, it is important that the valve is properly opened. If it is not fully opened, then an insufficient dose may be delivered. However, if there is a device counting the number of valve movements, it may well register a full movement. As a consequence, an incorrect record of dosage is generated.

The present invention is concerned with the monitoring of valve operation in such a manner that a valve movement is counted only when it is fully operated. As individual valves will not all have precisely the same closed and open positions, in order to accurately monitor proper valve usage, any monitoring device has to be individually calibrated for each valve. According to the present invention, calibration is accomplished in the combination of the valve and the monitoring device at the point at which the valve is first operated. Various combinations are described hereinafter.

In one embodiment of the invention, an optical system is used to activate a counting device. In this combination of valve and monitoring device, the valve is connected to a component movable between a valve open and valve closed position, and the device has a framework upon which is mounted a light sensor. The combination includes a light source and means defining a passage for light from the component when the component is in its valve open position. The valve open position of the component is established, and the light passage is defined, upon a first movement of the component to its valve open position. The sensor is coupled to a counter for counting subsequent movements of the component to the valve open position. In this way, the counting device will only register an operation of the valve when the component reaches the valve open position, and it will be appreciated that by using an optical system of the kind described the valve open position can be very precisely defined.

In this optical variant of the invention, the light passage can consist of a beam of light reflected from the component to the light sensor. A light source can be at a fixed location relative to the sensor and thus the reflected beam moves as the valve component moves, only activating the sensor when the component is at its valve open position. The sensor in this variant can comprise an array of detectors, and the light passage which confirms the component reaching its valve open position can thus be defined by the detector which receives a reflected beam of light when the component reaches its valve open position after its first movement. Such an array can comprise a matrix of photo silicon material.

The optical variant of the invention just described is particularly suitable for use with a pressurised canister in which the valve is fitted, and from which a valve stem extends. The framework can be fixed relative to the canister such that each time the valve component is moved the light beam correspondingly moves until the activating light passage is reached. The converse arrangement is also possible with a framework being fixed relative to the valve stem, and the component being mounted on the canister. In these arrangements, the framework is effectively provided separately, and calibration is accomplished when the canister and valve is fitted to the framework, and the valve operated for the first time.

In another optical variant of the invention, a light source can be mounted on the valve component itself, and activated to generate a beam of light upon the component reaching the valve open position. The same arrangement as described above can be used for receiving the light beam and thereby counting the number of times the valve is properly operated, with the sensor comprising an array of detectors, preferably in the form of a matrix of photo silicon material. The power source in this variant is typically a piezzo crystal or a voltaic polymer, adapted to be compressed to generate the light beam upon the component reaching its valve open position.

In yet another optical variant of the invention, the light source may be mounted on the valve component, and registers with the sensor when the component is in the valve open position, with the light passage passing through an opening in an element of the framework. This does of course require the opening to be properly located, and the opening may be created when the valve component moves for the first time to its valve open position. A laser can be used to accurately locate and cut the opening and by this means a very narrow beam of light can be generated for delivery to the light sensor. In these embodiments also, the light source may be a piezzo crystal or a voltaic polymer, compressible to generate the light beam.

The principle of the invention whereby a dose monitoring device is effectively calibrated when it is first put to use can also be embodied in arrangements which are responsive to pressure in a compression chamber, or changing resistance in an electrical circuit. In these variants, a dose monitoring device is disposed for mounting in an inhaler having a canister containing a pressurised medicant with a valve and a valve stem extending therefrom. The device comprises a framework for mounting on the canister, and a component for mounting on the valve stem, and movable between a valve closed and a valve open position. In an embodiment of the invention using a pressure switch, a pressure chamber is defined by elements fixed respectively relative to the framework and the component, and contractible upon movement of the component from the valve closed to the valve open position to pressurise the contents of the chamber. The pressure switch is located in the pressure chamber and coupled to a counting device for generating a signal each time it senses a threshold pressure in the chamber. The threshold pressure itself is established by that reached upon the first movement of the component from the valve closed to the valve open position. Conveniently, the pressure chamber can be defined by a bellows arrangement, and for the sake of symmetry and to avoid irregular fluctuations, the pressure chamber will normally surround the axis of the valve component.

In a dose monitoring device of the kind just described in which the counter is activated in response to the operation of a variable resistor, in place of the pressure chamber a variable resistor is defined between the component and a proximate element of the framework. The resistance of the resistor varies as the component moves between its valve closed and valve open positions, and a sensor is coupled to the resistor to sense its resistance when the component is in the valve open position.

The sensor is also coupled to a counting device for generating a signal each time that resistance is sensed, to monitor each proper operation of the valve. In order to ensure that this is the case, the resistance of the resistor when the component is at its valve open position is that sensed by the sensor upon the first movement of the component to its valve open position. Once again then, the device is calibrated upon initial activation.

In all embodiments of the invention a mechanism can be included which activates or “switches on” the counter upon each initial operation of the valve; ie, before the valve open position is reached. This enables the counter to remain dormant at other times, with the mechanism providing a warning or other signal which indicates to the counter that the valve is about to be activated. However, the counter will still not enter a “count” unless the valve open position is reached.

As noted above, the present invention has particular application in the field of inhalers, and those in which careful monitoring of inhaler usage is important. In this respect, reference is made to International Patent Publication No: WO 03/020349 which describes various means by which the use and operation of an inhaler can be monitored.

Embodiments of the invention will now be described by way of example, and with reference to the accompanying schematic drawings. In the drawings:

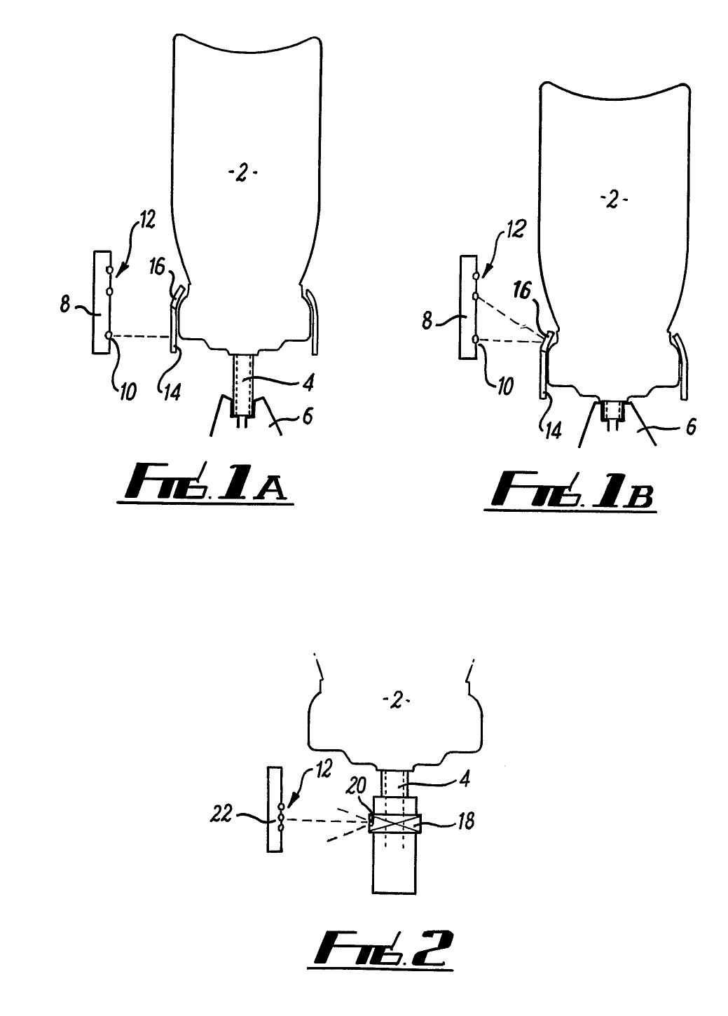

FIGS. 1A and 1 B show a canister with an extending valve stem in a combination according to one embodiment of the invention;

FIG. 2 shows a canister and valve stem in a combination according to a second embodiment of the invention;

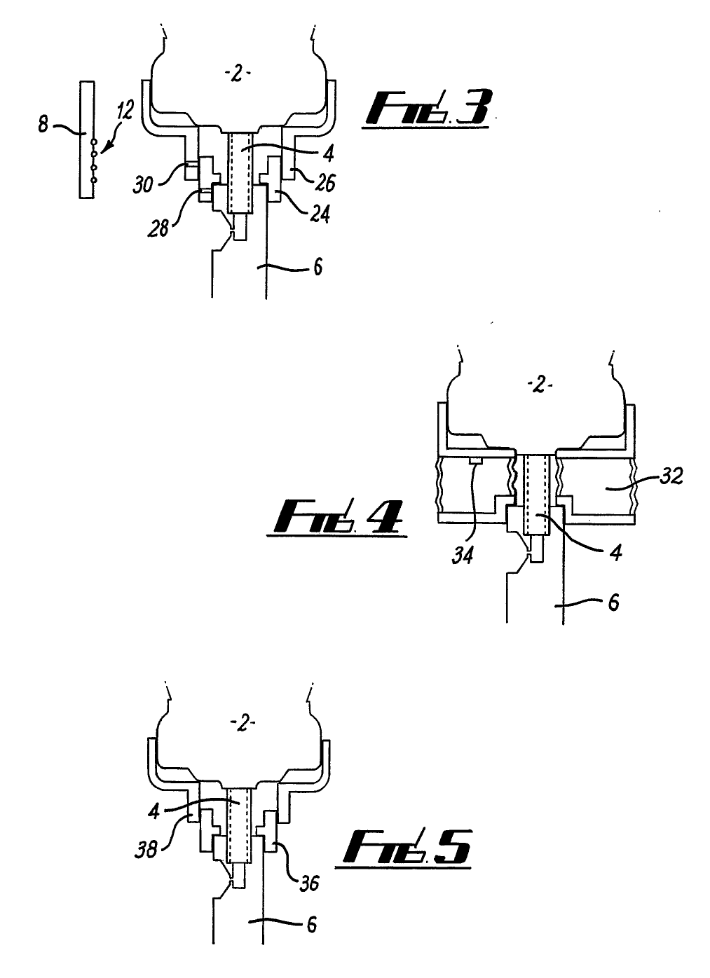

FIG. 3 shows a canister and valve stem in a combination according to a third embodiment of the invention;

FIG. 4 shows a canister and valve stem in a fourth embodiment of the invention; and

FIG. 5 shows a canister and valve stem in a combination according to a fifth embodiment of the invention.

FIGS. 1A and 1 B show a canister 2 of pressurised medicant which is released through a valve stem 4 projecting therefrom when the valve stem is depressed as shown in FIG. 1 B, to open a valve (not shown) within the canister. The valve is opened by lowering the canister 2 against a stop 6, which forces the valve stem 4 into the canister to open the valve. This operating procedure is standard in many aerosol-type containers, and will not be described in any further detail.

The stop 6 is part of a framework on which is mounted a plate 8 bearing a light source 10 and light receivers 12. The light source 10 is typically a light emitting diode (LED) whose emissions are collimated through a lens to transmit a parallel beam of light towards the canister 2. Fixed to the canister is a shield 14 having a reflective portion 16 inclined at a non-perpendicular angle to the incident beam from the light source 10 to reflect the beam away from the source and towards the array of detectors 12. As the canister is moved to depress the valve stem 4, the reflected beam will impinge on a different zone in the array of detectors 12. At the point when the stem reaches a point at which the valve is open and medicant from the canister 2 is discharged through the stem 4, the detector or zone of detectors upon which the reflected light beam impinges will define a valve open position for the valve stem. This information is related to a counter (not shown) which can thereafter monitor the taking of a dose of medicant each time the valve open position is subsequently reached.

The embodiment of FIGS. 1A and 1B enables a dispenser for medicant from the canister 2 to be calibrated when it is first used, and that calibration can be relied upon for the useful life of the canister provided the canister remains installed in the same framework with the stops 6 and plate 8 fixed in relation to each other. This would be common practice for many medicant dispensers in which a full canister is fitted to a housing which may readily be equipped with a suitably located plate 8. The shield 14 can be supplied as a separate component, and fitted to the canister before installation.

The embodiment of FIGS. 1A and 1 B requires a power supply for the light source. While this is not normally a problem, the embodiment illustrated in FIG. 2 avoids this necessity. In the embodiment of FIG. 2 the valve stem 4 of a canister 2 is fitted with an element 18 which upon distortion generates a small voltage. This in turn activates a light source 20, and any light generated thereby is sensed by detectors 12 on plate 22. The element 18 can be a piezzo crystal voltaic polymer, which is compressed by the movement of the valve stem 4 when it reaches its valve open position.

In both the embodiments of FIGS. 1A, 1 B and FIG. 2, initial movement of the valve stem relative to the canister, prior to it reaching the valve open position, can generate a signal to prepare the array of detectors and a counting device to receive a signal when the valve open position is reached. This can be accomplished in the embodiment of FIGS. 1A and 1 B by registration of a first deflected beam, and in the embodiment of FIG. 2 by applying pressure to the element 18 upon initial movement of the valve stem, and applying an increased pressure when the valve open position is reached.

In the embodiment of FIG. 3, a mount 24 at the end of the stop 6 moves with the stop, and relative to the canister 2 when the valve stem is depressed, in a cover 26 on the end of the canister. When the valve stem 4 reaches its valve open position, the cover 26 is adjusted on the end of the canister to align openings 28 and 30.

Alternatively, the holes 28 and 30 can be created during the system assembly process. A light source 25 is mounted in the chamber 27 defined by the cover 26 such that when the valve stem is in the valve open position and the holes 28 and 30 are aligned, a beam of light is transmitted through the aligned holes to an array of detectors on the plate 8. In other respects, this embodiment functions in a similar way to that of FIGS. 1A, 1B and FIG. 2.

In FIG. 4, in place of the optical system the valve open position of the valve stem 4 is established by means of pressure in a pressure chamber 32. A bellows construction defining the pressure chamber 32 is created on the canister 2 and around the valve stem 4, and a pressure switch 34 is mounted in the bellows chamber 32. When the valve stem 4 is depressed relative to the canister 2 the pressure in the chamber 32 rises and when the valve open position is reached the switch registers the pressure level reached. The sensor is coupled to a counter such that each time the registered pressure is subsequently reached, the counter counts the dispensing of a dose of medicant from the canister 2. The pressure sensor can operate by varying an applied voltage in response to changing ambient pressure.

The embodiment of FIG. 5 functions directly on the basis of varying electrical characteristics. Electrical elements on a mount 36 at the end of stop 6 cooperates with elements on cover 38 on the canister 2 to create a variable resistance corresponding to the relative position of the valve stem in the canister 2. The resistance of this combination is registered when the valve stem 4 reaches its valve open position, which resistance is once again relayed to the counter for subsequent recordal of each discharge of a dose of medicant.

The monitoring device in combinations of the invention can be permanently attached to a canister during the useful life of the canister. This enables the combination to carry a code which identifies the canister and is recognised by the counter each time the valve stem 4 moves to its valve open position. The counter can then properly register a count. The code is programmed into the counter when it receives the first signal. If the counter receives a signal with the wrong code, it will issue an appropriate alarm.

The invention can be exploited using inexpensive materials, with the structural elements being predominantly plastics mouldings. The light generators used can be low powered LDs, and the power sources piezzo crystals or voltaic polymers. These, together with the use of photo silicon material in the sensor, combine to create a low cost product with considerable benefit to users of medicant dispensers.

As will be apparent from this description, the present invention is directed at various means by which the operation of a valve can be monitored, with particular application to dispensers for medicants. The techniques described herein have a number of applications, and particularly can be exploited in dispensers of the kind described in our copending International Application filed today, entitled “Medicant Dispensers and Components Thereof”, and claiming convention priority from British Patent Application No: 04/04697.5.

1-21. (canceled)

22. The combination of a valve and a device for monitoring the operation thereof, in which the valve is connected to a component movable between a valve open and a valve closed position, and in which the device has a framework upon which is mounted a light sensor, the combination comprising: a light source mounted on the component; one of a piezzoelectric crystal and a voltaic polymer adapted to be compressed to activate the light source upon the component reaching the valve open position; and means defining a passage for light from the light source when the valve component is in the valve open position, wherein the valve open position of the component is established and said light passage defined upon a first movement of the component thereto, and wherein the sensor is coupled to a counter for counting subsequent movements of the component to the valve open position.

23. A combination according to claim 22 wherein the sensor comprises an array of detectors, and the light passage is defined by the detector receiving the beam of light generated upon the component reaching the valve open position.

24. A combination according to claim 23 wherein the array comprises a matrix of photo silicon material.

25. A combination according to claim 22 wherein the valve is installed in a pressurized canister and the component is mounted on a valve stem extending from the canister, the framework being fixed relative to the canister.

26. A combination according to claim 25 wherein the light source registers with the sensor when the component is in the valve open position with the light passage passing through an opening in an element of the framework.

27. A combination according to claim 26 wherein the opening in the framework element is formed upon the first movement of the component to the valve open position.

28. A combination according to claim 26 wherein the sensor comprises an array of detectors, and the light passage is defined by the detector receiving the beam of light generated upon the component reaching the valve open position.

29. A combination according to claim 22 including means for activating the counter upon initial operation of the component in the first and subsequent movements and prior to the component reaching the valve open position, to prepare the counter for counting.

30. An inhaler comprising a pressurized canister containing a medicant and having a valve installed thereon, and a device for monitoring operation of the valve, in which the valve is connected to a component movable between a valve open and a valve closed position, and in which the device has a framework upon which is mounted a light sensor, the inhaler including a light source mounted on the component; one of a piezzoelectric crystal and a voltaic polymer adapted to be compressed to activate the light source upon the component reaching the valve open position; and means defining a passage for light from the light source when the valve component is in the valve open position, wherein the valve open position of the component is established and the light passage defined upon a first movement of the component thereto, and wherein the sensor is coupled to a counter for counting subsequent movements of the component to the valve open position.

31. An inhaler according to claim 30 wherein the sensor comprises an array of detectors, and the light passage is defined by the detector receiving the beam of light generated upon the component reaching the valve open position.

32. An inhaler according to claim 31 wherein the array comprises a matrix of photo silicon material.

33. An inhaler according to claim 30 wherein the component is mounted on a valve stem extending from the canister, the framework being fixed relative to the canister.

34. An inhaler according to claim 33 wherein the light source registers with the sensor when the component is in the valve open position with the light passage passing through an opening in an element of the framework.

35. An inhaler according to claim 34 wherein the opening in the framework element is formed upon the first movement of the component to the valve open position.

36. An inhaler according to claim 34 wherein the sensor comprises an array of detectors, and the light passage is defined by the detector receiving the beam of light generated upon the component reaching the valve open position.

37. A combination according to claim 30 including means for activating the counter upon initial operation of the component in the first and subsequent movements and prior to the component reaching the valve open position, to prepare the counter for counting.

38. A dispensing device comprising a pressurized canister mounted in a framework to which is fitted a light sensor, the canister containing a medicant and having a valve installed thereon; and means for monitoring operation of the valve, in which the valve is connected to a component movable between a valve open and a valve closed position, and including a light source mounted thereon; one of a piezzoelectric crystal and a voltaic polymer adapted to be compressed to activate the light source upon the component reaching the valve open position; and means defining a passage for light from the light source when the valve component is in the valve open position, wherein the valve open position of the component is established and the light passage defined upon a first movement of the component thereto, and wherein the sensor is coupled to a counter for counting subsequent movements of the component to the valve open position.

39. A device according to claim 38 wherein the sensor comprises an array of detectors, and the light passage is defined by the detector receiving the beam of light generated upon the component reaching the valve open position.

40. A device according to claim 39 wherein the array comprises a matrix of photo silicon material.

41. A device according to claim 38 wherein the valve is installed in a pressurized canister and the component is mounted on a valve stem extending from the canister, the framework being fixed relative to the canister, and wherein the light source registers with the sensor when the component is in the valve open position with the light passage passing through an opening in an element of the framework.

42. A device according to claim 41 wherein the opening in the framework element is formed upon the first movement of the component to the valve open position.

43. A device according to claim 38 including means for activating the counter upon initial operation of the component in the first and subsequent movements and prior to the component reaching the valve open position, to prepare the counter for counting.
